(19) United States
(12) Patent Application Publication
(10) Pub. No.: US 2025/0360674 A1
(43) Pub. Date: Nov. 27, 2025

(54) BINDER JETTING OF STRONG GREEN PARTS WITH A GASEOUS CROSSLINKER

(71) Applicant: Chao MA, Gilbert, AZ (US)

(72) Inventor: Chao MA, Gilbert, AZ (US)

(73) Assignee: Arizona Board of Regents on Behalf of Arizona State University, Scottsdale, AZ (US)

(21) Appl. No.: 19/219,946

(22) Filed: May 27, 2025

Related U.S. Application Data
(60) Provisional application No. 63/651,870, filed on May 24, 2024.

(51) Int. Cl. B29C 64/165; B29C 64/371; B29K 286/00; B29K 309/00; B33Y 10/00; B33Y 40/20; B33Y 80/00

(52) U.S. Cl. CPC B29C 64/165; B29C 64/371; B33Y 10/00; B33Y 40/20; B33Y 80/00; B29K 2286/00; B29K 2309/00

(57) ABSTRACT

A method is provided for fabricating strong green parts using binder jetting in conjunction with a gaseous crosslinker. The process includes preparing a binder and a powder, printing the green part via selective binder deposition into powder layers, and exposing the green part to a gaseous crosslinker either during or after printing. The gaseous crosslinker chemically reacts with functional groups in the binder to form crosslinked networks, enhancing mechanical strength without requiring high-temperature sintering. In certain embodiments, polyethylenimine is used as the binder, Zeolite 13X as the powder, and carbon dioxide as the gaseous crosslinker, enabling the formation of chemically bonded green parts suitable for temperature-sensitive applications such as gas sorbents. The method enables full-part functionality, including tunable sorption properties and geometries, while expanding the range of materials compatible with binder jet fabrication.

### RELATED APPLICATIONS

This application claims the benefit of U.S. provisional patent application 63/651,870, filed May 24, 2024 to Chao Ma, titled “BINDER JETTING OF STRONG GREEN PARTS WITH A GASEOUS CROSSLINKER,” the entirety of the disclosure of which is hereby incorporated by this reference.

### TECHNICAL FIELD

This document relates to a method for fabricating a green part through binder jet fabrication with a gaseous crosslinker.

### BACKGROUND

Binder jetting is an additive manufacturing process with many advantages. It can be used with almost any material, such as ceramics, metals, and polymers. It can produce parts in a wide range of sizes, up to multiple meters. It can also produce parts with almost any geometry. For example, explicit support is not required for overhang structures. Furthermore, the energy consumption, operational cost, and capital cost of binder jetting are low.

A “green part” refers to the state of a part after the initial shaping process but before sintering. A challenging issue in binder jetting is that green parts are usually too weak to directly serve in many applications. Sintering is often performed to strengthen the green parts. However, sintering is not an option with materials that are sensitive to high temperatures, such as sorbents for gas separation (e.g., carbon capture sorbents, etc.).

### SUMMARY

According to some embodiments, a method for binder jetting of a green part comprises preparing a binder and a powder for binder jet fabrication, printing the green part by cyclically spreading a layer of powder and selectively jetting the binder through a printhead into the layer of powder while being exposed to a gaseous crosslinker, curing a job box containing loose powder and the green part comprising the binder, the powder, and the gaseous crosslinker, and depowdering the green part by removing the green part from the loose powder.

Particular embodiments may comprise one or more of the following features. The binder may comprise polyethylenimine. The powder may comprise Zeolite 13X. The gaseous crosslinker may comprise carbon dioxide. Preparing the binder may comprise mixing polyethylenimine with methanol.

According to some embodiments, a method for binder jetting of a green part comprises preparing a binder and a powder for binder jet fabrication, printing the green part by cyclically spreading a layer of powder and selectively jetting the binder through a printhead into the layer of powder, curing a job box containing loose powder and the green part comprising the binder, the powder, and a gaseous crosslinker, and depowdering the green part by removing the green part from the loose powder.

Particular embodiments may comprise one or more of the following features. Curing the job box may comprise exposing the green part to the gaseous crosslinker. Curing the job box may comprise heating the job box in a vacuum oven at 80° C. to evaporate all solvent, then heating the job box at 130° C. in a pure CO2 environment to crosslink the binder. Printing the green part may comprise exposing the green part to the gaseous crosslinker. The binder may comprise polyethylenimine. The powder may comprise Zeolite 13X. The gaseous crosslinker may comprise carbon dioxide. Preparing the binder may comprise mixing polyethylenimine with methanol.

According to some embodiments, a method for binder jetting of a green part comprises preparing a binder comprising a first sorbent and a powder comprising a second sorbent for binder jet fabrication, printing the green part by cyclically spreading a layer of powder and selectively jetting the binder through a printhead into the layer of powder, curing a job box containing loose powder and the green part comprising the binder, the powder, and a gaseous crosslinker, and depowdering the green part by removing the green part from the loose powder.

Particular embodiments may comprise one or more of the following features. Curing the job box may comprise exposing the green part to the gaseous crosslinker. Curing the job box may comprise heating the job box in a vacuum oven at 80° C. to evaporate all solvent, then heating the job box at 130° C. in a pure CO2 environment to crosslink the binder. Printing the green part may comprise exposing the green part to the gaseous crosslinker. The binder may comprise polyethylenimine. The powder may comprise Zeolite 13X. The gaseous crosslinker may comprise carbon dioxide.

According to some embodiments, a composition comprises a binder comprising a first sorbent, a powder comprising a second sorbent, and a gaseous crosslinker capable of forming covalent bonds with the first sorbent, wherein the binder and the gaseous crosslinker are configured to form a chemically bonded network. The powder may comprise a material selected from the group consisting of zeolites, silicas, aluminas, activated carbons, and cellulose. The composition may exhibit enhanced carbon dioxide sorption capacity relative to a composition comprising an inert binder. The composition may form the chemically bonded network without requiring thermal sintering above 150° C. The gaseous crosslinker may comprise carbon dioxide. The binder may comprise a polyamine. The powder may comprise Zeolite 13X.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1 is a schematic illustrating a method of fabricating strong green parts using binder jetting, where the binder is jetted in the presence of a gaseous crosslinker according to some embodiments.

FIG. 2 is a schematic illustrating a method of fabricating strong green parts using binder jetting, where the green part is cured in a gaseous crosslinker environment according to some embodiments.

FIG. 3 is a schematic illustrating a method of fabricating strong green parts using binder jetting, where the green part is cured in a gaseous crosslinker environment according to some embodiments.

FIGS. 4A and 4B provide a comparative diagram showing the difference in bonding between conventional processes and the presently disclosed method, with FIG. 4A showing a physically entangled network of PEI molecules in conventional processes and FIG. 4B showing the chemically bonded network formed using the gaseous crosslinker.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Contemplated herein is a method for the binder jetting of strong green parts using a gaseous crosslinker. A gaseous crosslinker, as used herein, refers to a reactive gas that facilitates chemical crosslinking between polymer chains within the green part. Gaseous crosslinkers enable in-situ or post-printing chemical bonding under relatively mild conditions. In this context, the gaseous crosslinker diffuses into the green part and reacts with functional groups (e.g., amines) in the binder to form covalent bonds, thereby converting a physically entangled polymer network into a chemically bonded one. This process can occur during or after printing and allows for enhanced mechanical integrity of the green part without requiring high-temperature sintering. Carbon dioxide (CO₂), for instance, can react with amine-containing binders like polyethylenimine, strengthening the green part and enabling use of temperature-sensitive materials.

In some embodiments, the bonds created through the presently disclosed gaseous crosslinker will allow binder jetting to produce strong green parts directly, without requiring high-temperature thermal processing. This capability opens up a new class of materials and applications that were not feasible with conventional binder jetting methods, such as allowing for binder jetting with heat-sensitive materials that cannot survive high-temperature thermal processing. According to various embodiments, the gaseous crosslinker facilitates the formation of covalent bonds among the binder molecules, resulting in a three-dimensional chemically bonded network in lieu of a physically entangled network. According to various embodiments, strong green parts can be used as sorbents for gas separation (such as carbon capture sorbent materials) and water treatment, catalysts, tooling, and the like.

Like conventional binder jetting itself, the gaseous crosslinker-based method contemplated herein opens up a staggering number of new applications for this manufacturing technology. One particular application is the manufacturing of objects out of material that can absorb carbon dioxide, for the purpose of carbon capture.

Based on the U.N. IPCC's latest comprehensive assessment, the deployment of CO2 removal technologies will be necessary to achieve net zero emissions. According to U.N. IPCC's prediction, at least 2 gigatonnes of CO2 must be removed from the atmosphere by 2030. The U.S. government is providing a financial incentive of $130-180 per tonne of CO2 removed through direct air capture (i.e., directly capturing CO2 from the atmosphere). With these values, the market is estimated to be on the scale of ˜$100 billion. Furthermore, the amount of CO2 needing to be removed will significantly increase in the coming decades, meaning this huge market will continue to expand.

The gaseous crosslinker-based method contemplated herein holds the potential to significantly improve the performance of these direct air capture products. The economics driving the use of direct air capture leave the devices a very thin energy budget to operate within. The ability to shape sorbent materials into almost any geometry will make it possible to maximize exposure at minimal energy cost. In some cases, these shapes may also accelerate the release of the captured carbon dioxide through exposure to a release medium (e.g., water, steam, heat, electricity, etc.), depending upon the sorbent material.

Of course, sorbent materials is one of many temperature-sensitive materials that can be shaped into strong green parts using the gaseous crosslinker-based methods contemplated herein. The improved binder jetting process holds the potential to significantly expand the application space of this already versatile technology.

The binder jetting process incorporating a gaseous crosslinker 100 may generally be divided into four major stages: (1) material preparation; (2) printing; (3) curing; and (4) depowdering. First, the powder 102 and the binder 104 are prepared. These raw materials are chosen and prepared to have favorable characteristics for the downstream processes and applications.

In some embodiments, the binder 104 is polyethylenimine (PEI), the powder 102 is Zeolite 13X, and the gaseous crosslinker 100 is carbon dioxide (CO2). In some embodiments, PEI is diluted in methanol or another alcohol to reduce viscosity and improve jetting stability. Optional pH adjustments or surfactants may be used to stabilize the binder formulation for extended use in drop-on-demand printheads. In a particular example, the binder 104 is prepared by adding PEI to methanol and stirring for 2 hours. The Zeolite 13X powder 102 may be dried in an oven at 150° C. under vacuum for 3 hours before being used for binder jetting.

It should be noted that the use of a first sorbent (e.g., PEI herein) as a binder 104 and a second sorbent (e.g., zeolite herein) as a powder 102 is a novel combination in binder jetting, even without applying the contemplated method for strengthening green parts. Conventional efforts to shape carbon dioxide sorbents using binder jetting techniques have been limited to compositions where the binder does not sorb CO2. The use of a sorbent as a binder 104 is advantageous because it will sorb carbon dioxide, as does the powder 102. Accordingly, novel sorbent structures may be fabricated through binder jetting by using a first sorbent as the binder 104 and a second sorbent as the powder 102. This approach represents a novel binder-powder pairing in the context of sorbent shaping for gas separation. The use of a sorbent binder 104 in conjunction with a sorbent powder 102 enables printed green parts 106 in which the entire structure contributes to carbon dioxide sorption, potentially increasing uptake capacity, kinetics, or regeneration characteristics compared to conventional sorbent shaping methods where the binder is inert. Some of these printed structures (i.e., green parts) may be further strengthened using the methods and gaseous crosslinkers contemplated herein.

Next is the printing of the green part 106. According to various embodiments, printing can be done with any binder jetting machines, using the binder 104 and powder 102 described above. The process starts with spreading a uniform layer of powder 102. This may be done by adding powder 102 to the job box 108 and moving a recoater roller or recoater blade 110 across the job box 108 to level the powder 102. The binder 104 is then selectively jetted through a printhead 112 according to the cross-sectional shape of the desired parts. These procedures are repeated layer by layer until the entire parts are built.

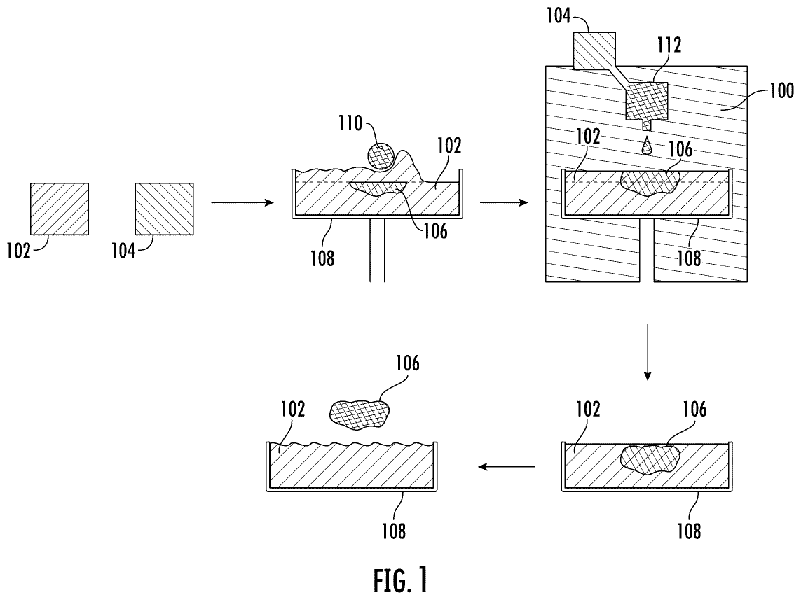

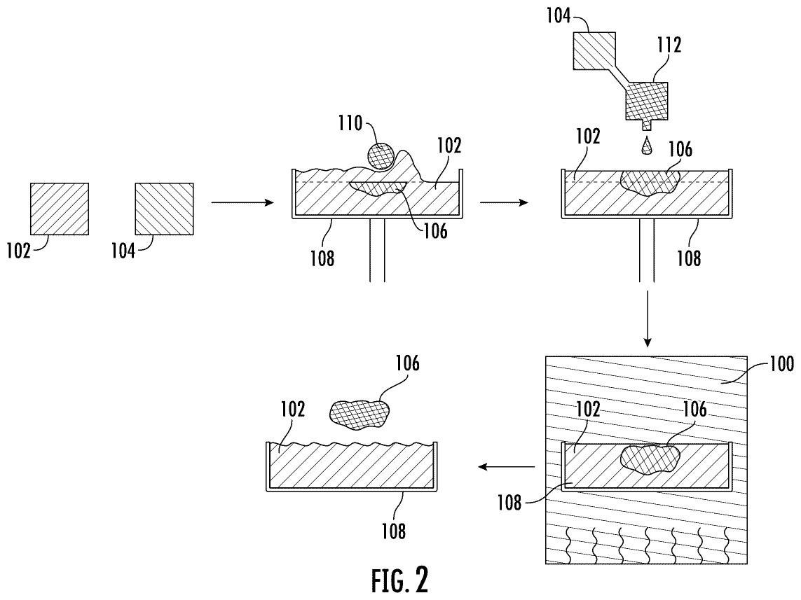

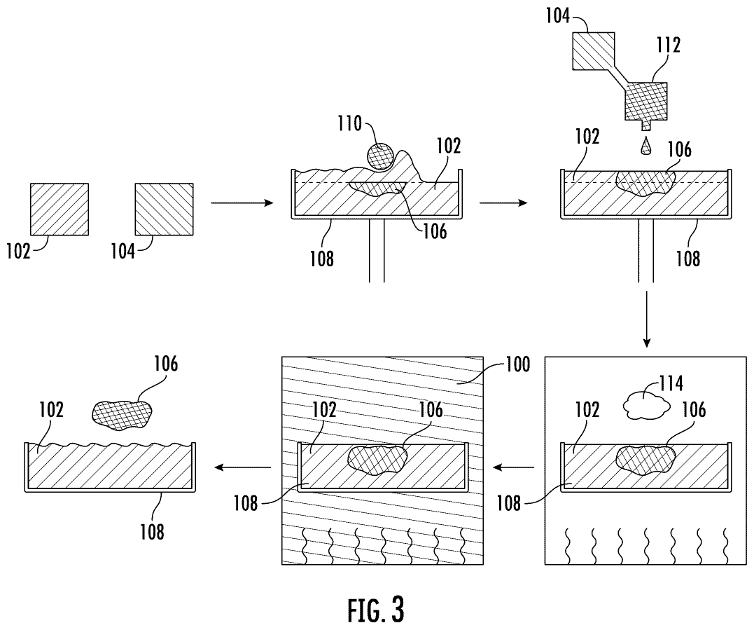

In some embodiments, the binder 104 and the powder 102 are exposed to the gaseous crosslinker 100 during the printing step, as shown in FIG. 1. For example, in some embodiments, the selective jetting of the binder into the powder may be performed in an environment comprising the gaseous crosslinker (e.g., a gaseous crosslinker-rich environment, an environment of pure gaseous crosslinker, etc.). In other embodiments, the gaseous crosslinker may be introduced to the binder 104 and the powder 102 during a curing step by curing the green part 106 in an environment comprising the gaseous crosslinker 100, as shown in FIGS. 2 and 3. A person of skill in the art will understand that, in some embodiments, the green part 106 may be printed and cured in an environment comprising the gaseous crosslinker 100. In addition, a person of skill in the art will understand that an environment comprising the gaseous crosslinker 100 is not necessarily 100% gaseous crosslinker 100, and that other gases may also be present.

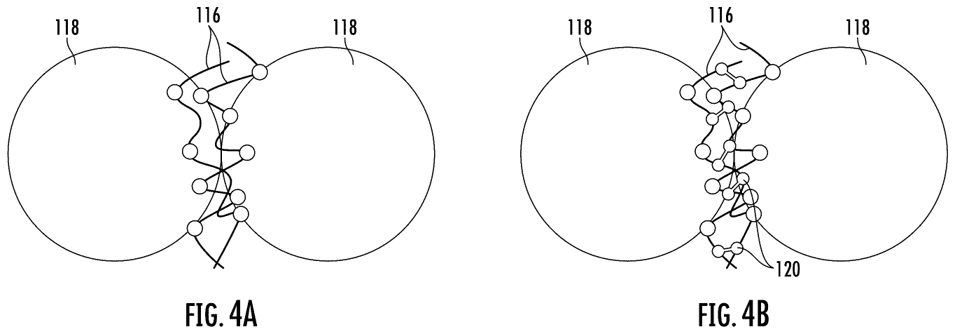

After the printing comes the curing that strengthens the green parts 106. According to various embodiments, the curing is performed by placing the entire job box 108 containing the printed parts 106 and the loose powder 102 in a vacuum oven for curing. In some embodiments, the curing is performed in two steps, as shown in FIG. 3. First, the entire job box 108 is cured at 80° C. under vacuum for 8 hours to fully evaporate the solvent 114. The second step is to crosslink the PEI molecules in a pure CO2 environment (the gaseous crosslinker 100 in this embodiment) at 130° C. According to various embodiments, this second curing step may be done for different durations including, but not limited to, 0.5, 1, 2, 5, and 10 hours, according to various embodiments. These green parts 106 have now been strengthened by covalent bonds formed among the binder molecules (FIG. 4B), therefore resulting in a chemically bonded binder network in lieu of a physically entangled network.

Traditional binder jetting systems operate under ambient conditions, often in open-air environments or within lightly controlled chambers. When introducing reactive gases like CO₂ during printing or curing, it may be necessary to modify the build chamber or curing oven to maintain a stable gas composition. In some embodiments, the build chamber may be sealed and continuously purged with CO₂ to create a reactive atmosphere during printing, while ensuring no adverse effects on the jetting mechanism. Printhead components should be selected or configured to resist degradation from the gas environment. Alternatively, crosslinking may occur post-printing in a closed curing chamber equipped to handle reactive gas flow at defined temperatures and pressures. These environmental controls ensure consistent gas diffusion throughout the green part 106 and uniform chemical bonding. The timing and staging of the gas exposure can be optimized to balance printing speed, resolution, and mechanical strength of the final green part.

The final step, according to various embodiments, is depowdering, where the green parts 106 are retrieved from the surrounding loose powder 102. In some embodiments, the green part 106 may be depowdered before the green part 106 has fully cured.

In this specific, non-limiting example, the binder 104 was PEI (a polyamine), the powder 102 was Zeolite 13X, and crosslinker 100 was carbon dioxide. The chemical mechanism by which the gaseous crosslinker 100 strengthens the green part 106 involves the formation of covalent bonds between reactive functional groups on the binder polymer 104 and the gaseous crosslinker 100. In the specific case of polyethylenimine (PEI) and carbon dioxide (CO₂), CO₂ reacts with primary and secondary amines to form chemical crosslinks, transforming the binder matrix from a physically entangled network to a chemically crosslinked polymer structure. The extent of crosslinking can be modulated by controlling the exposure time, temperature, CO₂ concentration, and moisture content, which can act as a co-reactant in certain conditions. This transformation imparts significantly improved mechanical integrity to the green part. According to various embodiments, carbon dioxide will work with other binders 104 as well, including, but not limited to, other polyamines and other compounds containing amine functional groups. Additionally, other embodiments may comprise any other powder known in the art.

According to various embodiments, other suitable binders 104 may include, but are not limited to, polyamines, polyacrylamides, polyvinyl alcohols, polysaccharides, and other water-soluble or alcohol-soluble polymers that possess reactive functional groups. The powder 102 may comprise any particulate material suitable for binder jetting, including, for example, silica, alumina, activated carbon, cellulose, or other inorganic or organic powders having appropriate flow and packing characteristics. The selection of binder 104, powder 102, and gaseous crosslinker 100 may be tailored based on the target application, chemical compatibility, and mechanical performance requirements of the green parts 106.

FIGS. 4A and 4B illustrate the difference between the bonds formed in green parts made via conventional binder jetting processes, and the strengthened green parts 106 formed using the gaseous crosslinker-based methods contemplated herein. As shown, in the baseline case shown in FIG. 4A, PEI molecules 116 (i.e., the binder 104) form a physically entangled network among the zeolite particles 118 (i.e., the powder 102. This physically entangled network is not as strong as the chemical bonds formed using the gaseous crosslinker method contemplated herein. As shown in FIG. 4B, when using the contemplated method, a gaseous crosslinker 100 is introduced during the printing or curing step, enabling PEI molecules 116 to form a chemically bonded network in lieu of a physically entangled network. The chemically bonded network has crosslinks 120 that strengthen the part 106. This ultimately results in stronger green parts 106.

The incorporation of a gaseous crosslinker 100 into the binder jetting workflow, as described above, allows for tailoring of bond strength, geometry, and material compatibility. This significantly broadens the range of usable materials and eliminates the need for post-processing sintering in many cases. Functionality of the resulting parts is broadened, including improved mechanical integrity and compatibility with non-sinterable materials, while also reducing processing cost and complexity.

A person of ordinary skill in the art, having the benefit of this disclosure, will recognize that the presently described method can be extended to a wide variety of binder-powder-crosslinker systems. The nature of the binder 104, powder 102, and gaseous crosslinker 100 may be selected based on application-specific parameters such as target chemical functionality, porosity, sorption behavior, or mechanical robustness. As such, the presently disclosed systems and methods are adaptable to numerous functional materials and are not limited to the specific combinations described herein.

The present disclosure is related to a composition that may be produced using the method described above, or another method. The composition may comprise the binder 104, the powder 102, and the gaseous crosslinker 100. In some embodiments, the binder 104 comprises a first sorbent and the powder 102 comprises a second sorbent. The gaseous crosslinker 100 may be capable of forming covalent bonds with the first sorbent. The binder 104 and the gaseous crosslinker 100 may be configured to form a chemically bonded network. The powder 102 may comprise a material selected from the group consisting of zeolites, silicas, aluminas, activated carbons, and cellulose. In some embodiments, the composition exhibits enhanced carbon dioxide sorption capacity relative to a composition comprising an inert binder. The composition may form the chemically bonded network without requiring thermal sintering above 150° C. As noted above, the gaseous crosslinker 100 may comprise carbon dioxide, the binder 104 may comprise a polyamine, and/or the powder 102 may comprise Zeolite 13X.

Many additional implementations, variations, and optimizations based on the disclosed principles are possible and will be apparent to one of ordinary skill in the art. Further implementations are within the CLAIMS.

It will be understood that implementations are not limited to the specific components disclosed herein, as virtually any components consistent with the intended operation of a method and/or system implementation for binder jetting of strong green parts using a gaseous crosslinker may be utilized. Accordingly, for example, although particular binders, powders, and gaseous crosslinkers may be disclosed, such components may comprise any shape, size, style, type, model, version, class, grade, measurement, concentration, material, weight, quantity, and/or the like consistent with the intended operation of a method and/or system implementation for binder jetting of strong green parts using a gaseous crosslinker.

In places where the description above refers to particular implementations of binder jetting of strong green parts using a gaseous crosslinker, it should be readily apparent that a number of modifications may be made without departing from the spirit thereof and that these implementations may be applied to other additive fabrication processes. The presently disclosed methods and systems are, therefore, to be considered in all respects as illustrative and not restrictive.

I claim:

1. A method for binder jetting of a green part, the method comprising:
preparing a binder and a powder for binder jet fabrication;
printing the green part by cyclically spreading a layer of powder and selectively jetting the binder through a printhead into the layer of powder while being exposed to a gaseous crosslinker;
curing a job box containing loose powder and the green part comprising the binder, the powder, and the gaseous crosslinker; and
depowdering the green part by removing the green part from the loose powder.

2. The method of claim 1, wherein the binder comprises polyethylenimine.

3. The method of claim 1, wherein the powder comprises Zeolite 13X.

4. The method of claim 1, wherein the gaseous crosslinker comprises carbon dioxide.

5. The method of claim 1, wherein preparing the binder comprises mixing polyethylenimine with methanol.

6. A method for binder jetting of a green part, the method comprising:
preparing a binder and a powder for binder jet fabrication;
printing the green part by cyclically spreading a layer of powder and selectively jetting the binder through a printhead into the layer of powder;
curing a job box containing loose powder and the green part comprising the binder, the powder, and a gaseous crosslinker; and
depowdering the green part by removing the green part from the loose powder.

7. The method of claim 6, wherein curing the job box comprises exposing the green part to the gaseous crosslinker.

8. The method of claim 7, wherein curing the job box comprises heating the job box in a vacuum oven at 80° C. to evaporate all solvent, then heating the job box at 130° C. in a pure CO2 environment to crosslink the binder.

9. The method of claim 6, wherein printing the green part comprises exposing the green part to the gaseous crosslinker.

10. The method of claim 6, wherein the binder comprises polyethylenimine.

11. The method of claim 6, wherein the powder comprises Zeolite 13X.

12. The method of claim 6, wherein the gaseous crosslinker comprises carbon dioxide.

13. The method of claim 6, wherein preparing the binder comprises mixing polyethylenimine with methanol.

14. A composition, comprising:
a binder comprising a first sorbent;
a powder comprising a second sorbent; and
a gaseous crosslinker capable of forming covalent bonds with the first sorbent,
wherein the binder and the gaseous crosslinker are configured to form a chemically bonded network.

15. The composition of claim 14, wherein the powder comprises a material selected from the group consisting of zeolites, silicas, aluminas, activated carbons, and cellulose.

16. The composition of claim 14, wherein the composition exhibits enhanced carbon dioxide sorption capacity relative to a composition comprising an inert binder.

17. The composition of claim 14, wherein the composition forms the chemically bonded network without requiring thermal sintering above 150° C.

18. The composition of claim 14, wherein the gaseous crosslinker comprises carbon dioxide.

19. The composition of claim 14, wherein the binder comprises a polyamine.

20. The composition of claim 14, wherein the powder comprises Zeolite 13X.
